(19) United States
(12) Patent Application Publication
(10) Pub. No.: US 2026/0267938 A1
(43) Pub. Date: Sep. 10, 2026

(54) TECHNIQUE FOR EFFICIENT MULTIPLICATION OF VECTORS OF COMPLEX NUMBERS

(71) Applicant: Arm Limited, Cambridge (GB)

(72) Inventors: Jelena MILANOVIC, Antibes (FR); Eric BISCONDI, Grasse (FR); Mohamad Mathieu NAJEM, Antibes (FR)

(73) Assignee: Arm Limited, Cambridge (GB)

(21) Appl. No.: 19/165,793

(22) PCT Filed: Feb. 1, 2024
(86) PCT No.: PCT/GB2024/050278

§ 371 Date: Sep. 16, 2025

(30) Foreign Application Priority Data
Mar. 29, 2023 (GB) 2304618.8

(51) Int. Cl. G06F 17/16

(52) U.S. Cl. CPC G06F 17/16

(57) ABSTRACT

Processing circuitry is provided to perform vector operations, with instruction decoder circuitry used to decode instructions from a set of instructions to control the processing circuitry to perform the vector operations specified by the instructions. Array storage that has storage elements to store data blocks is used to store at least one two-dimensional array of data blocks accessible to the processing circuitry when performing the vector operations. The set of instructions comprises a complex valued outer product instruction specifying a first source operand, a second source operand, and a destination operand, wherein each of the first source operand and the second source operand is a vector operand comprising a plurality of source data elements, each source data element is a complex number formed of a real part and an imaginary part, and the destination operand identifies a given two-dimensional array of data blocks within the array storage. The processing circuitry is responsive to the complex valued outer product instruction to perform an outer product operation using the source data elements of the first source operand and the source data elements of the second source operand in order to generate a plurality of result data elements, where each result data element is a complex number formed of a real part and an imaginary part, and where each real part and each imaginary part of each result data element is associated with one of the data blocks in the given two-dimensional array of data blocks and is used to update a value of that associated data block.

### BACKGROUND

The present technique relates to the field of data processing, and more particularly to a technique for performing efficient multiplication of complex numbers.

Multiple complex numbers may be provided within a vector, so as to enable vector computations to be performed in order to seek to improve performance, for example by enabling multiple complex numbers to be processed in parallel. However, there can still be a significant performance impact associated with performing computations on complex numbers, which often requires execution of multiple vector instructions in order to perform the required computations.

There are many computational tasks where complex-valued arithmetic is required, for example in digital signal processing (DSP) algorithms, in communication infrastructure 5G applications, in high performance computing (HPC) applications, etc. Often multiplication of complex numbers is required, and given the demands on computational resources typically needed to perform such complex valued multiplication operations, it would be desirable to provide techniques for accelerating such multiplication operations, to thereby improve performance/throughput.

### SUMMARY

In one example arrangement, there is provided an apparatus comprising: processing circuitry to perform vector operations; instruction decoder circuitry to decode instructions from a set of instructions to control the processing circuitry to perform the vector operations specified by the instructions; and array storage comprising storage elements to store data blocks, the array storage being arranged to store at least one two-dimensional array of data blocks accessible to the processing circuitry when performing the vector operations; wherein: the set of instructions comprises a complex valued outer product instruction specifying a first source operand, a second source operand, and a destination operand, wherein each of the first source operand and the second source operand is a vector operand comprising a plurality of source data elements, each source data element is a complex number formed of a real part and an imaginary part, and the destination operand identifies a given two-dimensional array of data blocks within the array storage; and the processing circuitry is responsive to the complex valued outer product instruction to perform an outer product operation using the source data elements of the first source operand and the source data elements of the second source operand in order to generate a plurality of result data elements, where each result data element is a complex number formed of a real part and an imaginary part, and where each real part and each imaginary part of each result data element is associated with one of the data blocks in the given two-dimensional array of data blocks and is used to update a value of that associated data block.

In another example arrangement, there is provided a method comprising: performing vector operations using processing circuitry; decoding instructions from a set of instructions to control the processing circuitry to perform the vector operations specified by the instructions; and employing array storage comprising storage elements to store data blocks, the array storage being arranged to store at least one two-dimensional array of data blocks accessible to the processing circuitry when performing the vector operations; wherein: the set of instructions comprises a complex valued outer product instruction specifying a first source operand, a second source operand, and a destination operand, wherein each of the first source operand and the second source operand is a vector operand comprising a plurality of source data elements, each source data element is a complex number formed of a real part and an imaginary part, and the destination operand identifies a given two-dimensional array of data blocks within the array storage; and the method comprises, in response to the complex valued outer product instruction, employing the processing circuitry to perform an outer product operation using the source data elements of the first source operand and the source data elements of the second source operand in order to generate a plurality of result data elements, where each result data element is a complex number formed of a real part and an imaginary part, and where each real part and each imaginary part of each result data element is associated with one of the data blocks in the given two-dimensional array of data blocks and is used to update a value of that associated data block.

In a still further example arrangement, there is provided a computer program for controlling a host data processing apparatus to provide an instruction execution environment, comprising: processing program logic to perform vector operations; instruction decode program logic to decode instructions from a set of instructions to control the processing program logic to perform the vector operations specified by the instructions; and array storage emulating program logic to emulate an array storage comprising storage elements to store data blocks, the array storage being arranged to store at least one two-dimensional array of data blocks accessible to the processing program logic when performing the vector operations; wherein: the set of instructions comprises a complex valued outer product instruction specifying a first source operand, a second source operand, and a destination operand, wherein each of the first source operand and the second source operand is a vector operand comprising a plurality of source data elements, each source data element is a complex number formed of a real part and an imaginary part, and the destination operand identifies a given two-dimensional array of data blocks within the array storage; and the processing program logic is responsive to the complex valued outer product instruction to perform an outer product operation using the source data elements of the first source operand and the source data elements of the second source operand in order to generate a plurality of result data elements, where each result data element is a complex number formed of a real part and an imaginary part, and where each real part and each imaginary part of each result data element is associated with one of the data blocks in the given two-dimensional array of data blocks and is used to update a value of that associated data block. Such a computer program can be disposed in any known transitory computer-readable medium (such as wired or wireless transmission of code over a network) or non-transitory computer-readable medium such as semiconductor, magnetic disk, or optical disc.

### BRIEF DESCRIPTION OF THE DRAWINGS

The present technique will be described further, by way of illustration only, with reference to examples thereof as illustrated in the accompanying drawings, in which:

FIG. 1 is a block diagram of a data processing apparatus;

FIG. 2 shows an example of architectural registers that may be provided within the apparatus, including vector registers for storing vector operands and array registers for storing 2D arrays of data elements, including an example of a physical implementation of the array registers;

FIGS. 3A and 3B schematically illustrate how accesses may be performed to a square 2D array within the array storage;

FIG. 4A illustrates an outer product operation;

FIG. 4B illustrates a matrix multiplication operation;

FIG. 5 is a block diagram of an apparatus in accordance with one example implementation, illustrating how the processing circuitry may be used to perform outer product operations on vectors of complex numbers;

FIG. 6 is a flow diagram illustrating steps performed in accordance with one example implementation, in order to perform outer product operations on vectors of complex numbers;

FIG. 7 illustrates dot product circuitry that may be used to perform a dot product operation on real numbers;

FIG. 8 illustrates how two instances of the dot product circuitry of FIG. 7 can be used to multiply two complex numbers, as part of a complex valued outer product and accumulate operation performed on two vectors of complex numbers;

FIG. 9 illustrates the performance of an outer product operation on two vectors of complex numbers, using multiple instances of dot product circuits;

FIG. 10 illustrates how input manipulation circuitry can be provided in association with dot product circuits in accordance with one example implementation, in order to adjust how the real and imaginary parts of at least one source data element are provided to the associated dot product circuits;

FIG. 11 is a diagram illustrating in more detail the input manipulation circuitry used in accordance with one example implementation;

FIGS. 12A to 12C illustrate how the data manipulation circuitry may be used in association with a pair of dot product circuits such as illustrated in FIG. 8, in order to allow a variety of other variants of complex valued outer product operations to be performed;

FIG. 13 illustrates how an array of multiplier-based circuits can be used to support the performance of outer product operations on vectors of real numbers, and how pairs of those circuits may be combined to support the dot product computations used when performing an outer product operation on vectors of complex numbers in accordance with one example implementation;

FIG. 14 schematically illustrates an eight way dot product circuit that can be used when performing a dot product operation on two vectors of eight real numbers;

FIG. 15 illustrates how multiple instances of such an eight way dot product circuit can be used when performing a sum of outer products operation on vectors of complex numbers in accordance with one example implementation;

FIG. 16 illustrates the performance of a sum of outer products operation on two vectors of complex numbers, using multiple instances of dot product circuits;

FIG. 17 schematically illustrates how the real and imaginary parts of the complex numbers in one of the vectors may be manipulated prior to provision to a pair of dot product circuits when performing sum of outer products operations, in accordance with one example implementation; and

FIG. 18 illustrates a simulator implementation that may be used.

### DESCRIPTION OF EXAMPLES

In accordance with the techniques described herein, an apparatus is provided that has processing circuitry for performing vector operations, and instruction decoder circuitry for decoding instructions from a set of instructions in order to control the processing circuitry to perform the vector operations specified by those instructions. For example, the instruction decoder circuitry may be responsive to the instructions in the set of instructions to generate control signals, and the control signals may control the processing circuitry to perform vector operations.

Vector operations are operations performed on vector operands—e.g. operands comprising multiple data elements. Vector operations can include any operation that involves at least one vector operand, such as a load or store operation to load/store a vector from/to a storage location (e.g. memory or a cache) or an arithmetic operation (e.g. addition, multiplication) performed on vector operands. In the present technique, the processing circuitry is capable of performing vector operations that include at least outer product operations. Vector operands may (but need not necessarily) be stored in vector registers, where a single vector register may store an entire vector operand, or where a single vector operand may be spread between multiple vector registers (and hence a single vector register may store elements from multiple vector operands).

In accordance with the techniques described herein, array storage is also provided, the array storage comprising storage elements to store data blocks, and being arranged to store at least one two-dimensional array of data blocks accessible to the processing circuitry when performing the vector operations.

Further, in accordance with the techniques described herein, the set of instructions comprises a complex valued outer product instruction that specifies a first source operand, a second source operand and a destination operand. Each of the first source operand and the second source operand is a vector operand comprising a plurality of source data elements, and each source data element is a complex number formed of a real part and an imaginary part. The destination operand is arranged to identify a given two-dimensional array of data blocks within the array storage. It should be noted that the terms “first” and “second” are merely labels, and the first and second source operands need not necessarily be the first and second operands specified by the complex valued outer product instruction, respectively. On the contrary, the first and second operands could be identified by the complex valued outer product instruction in either order.

The processing circuitry is responsive to the complex valued outer product instruction to perform an outer product operation using the source data elements of the first source operand and the source data elements of the second source operand, in order to generate a plurality of result data elements. Each result data element is a complex number formed of a real part and an imaginary part, and each real part and each imaginary part of each result data element is associated with one of the data blocks in the given two-dimensional array of data blocks, and is used to update a value of that associated data block.

In some instances there may be a one-to-one correspondence between a real part of a result data element and the associated data block in the 2D array, and similarly between an imaginary part of a result data element and the associated data block in the 2D array, and hence a value in any given data block may be updated in dependence on the associated real part or imaginary part of one of the result data elements. However, in some other instances, such as when performing complex valued sum of outer product operations (discussed in more detail later), the real parts of multiple result data elements may be associated with one corresponding data block in the 2D array, and similarly the imaginary parts of multiple result data elements may be associated with one corresponding data block in the 2D array, and in that instance a value in any given data block is updated in dependence on the multiple associated real parts or multiple associated imaginary parts.

By defining an instruction (the complex valued outer product instruction) that enables an outer product operation to be performed on vectors of complex numbers in response to a single instance of the instruction, significant performance and throughput benefits can be realised when performing tasks that require intensive use of multiplication operations in respect of complex numbers. In particular, by such an approach, execution of a single instruction can be used to perform multiplications of vectors of complex numbers, whereas previously multiple instructions would need to be executed to perform the computations required to produce the multiplication results. Further, efficient use of processing resources can be achieved by arranging the desired multiplications to be performed via an outer product operation, with the results being used to update a two-dimensional array of data blocks provided within the array storage. This, for example, readily enables accumulation (or subtraction) operations to be incorporated when performing the computations, which can provide a number of additional benefits. For example by using the same destination operand (i.e. the same two-dimensional array of data blocks) for multiple instances of the complex valued outer product instruction, this can provide a particularly efficient mechanism for performing matrix multiplication operations on vectors of complex numbers.

In one example implementation, both the first source operand and the second source operand are configured to interleave the real parts of the plurality of source data elements and the imaginary parts of the plurality of source data elements. This enables a particularly efficient implementation when performing the outer product operation, by allowing the data elements required for the various computational blocks within the processing circuitry to be logically grouped for provision to those computational blocks. In particular, in one example implementation a separate computational block may be used to generate each part (real or imaginary) of each result data element, and each computational block will require the provision as inputs of real and imaginary parts of at least two data elements (at least one from each source operand), and hence by interleaving the real and imaginary parts of the plurality of source data elements within each source operand this can enable a reduction in the complexity of the routing circuitry used to provide the required inputs to each computational block.

Furthermore, in one example implementation, within at least one dimension of the given two-dimensional array of data blocks, the real parts and the imaginary parts of multiple result data elements are associated with the data blocks such that the real parts of the multiple result data elements are interleaved with the imaginary parts of the multiple result data elements. Again, this can enable a particularly efficient implementation, reducing routing complexity between computational blocks and the associated data blocks within the two-dimensional array.

The processing circuitry can be configured in a variety of ways in order to enable the outer product operation to be performed. However, in one example implementation, the processing circuitry comprises dot product circuitry associated with each data block in the given two-dimensional array of data blocks. The dot product circuitry associated with a given data block may be arranged to perform a dot product operation using the real parts and the imaginary parts of at least one source data element of the first source operand and at least one source data element of the second source operand in order to produce a required part (which depending on the dot product circuit under consideration may be either the real part or the imaginary part) of at least one result data element that is to be used to update the value of the given data block. By using multiple instances of dot product circuitry, this can allow a particularly efficient implementation of the circuitry required within the processing circuitry to perform the outer product operation on vectors of complex numbers. Indeed, in some implementations, such dot product circuitry may already be present within the apparatus for other purposes, or can readily be instantiated by combining groups of components already provided for other purposes.

In one example implementation, the apparatus further comprises input manipulation circuitry associated with each data block in the given two-dimensional array of data blocks, wherein the input manipulation circuitry associated with the given data block is controlled in dependence on the complex valued outer product instruction to perform an input manipulation operation to adjust how the real and imaginary parts of at least one source data element are provided to the dot product circuitry associated with the given data block in order to ensure that the performance of the dot product operation produces the required part of the at least one result data element that is to be used to update the value of the given data block. In particular, in order for the dot product circuitry to produce the required outputs it may be necessary to invert one of the input parts, for example a real part or an imaginary part, of at least one of the source data elements, and/or to reorder the real and imaginary parts of at least one of the source data elements, and such functions can readily be performed by the input manipulation circuitry. Further, the provision of such input manipulation circuitry can provide additional flexibility, for example by enabling the same dot product circuitry to be used when implementing a variety of different variants of the complex valued outer product instruction, by adjusting how the various parts of the source data elements are manipulated prior to provision to the dot product circuitry, in dependence on the particular variant of the complex valued outer product instruction.

Whilst in some implementations the input manipulation circuitry may be provided so as to enable manipulations to be performed in respect of data elements in either of the first and second source operands, in one particular implementation the input manipulation circuitry is provided in association with only one of the two source operands in order to manipulate as required the data elements of that source operand, such that no manipulation is required to the data elements of the other source operand. Such an approach can lead to a particularly efficient and lower cost design, for example due to reduced hardware complexity and reduced power consumption.

The input manipulation circuitry can take a variety of forms, but in one example implementation comprises inverter circuitry to invert the value of at least one part of the at least one source data element, and/or reordering circuitry to swap an ordering of real and imaginary parts of the at least one source data element.

In one example implementation, a plurality of variants of the complex valued outer product instruction are supported by the apparatus, and the input manipulation operation performed by the input manipulation circuitry associated with the given data block is dependent on the variant of the complex valued outer product instruction being executed, so as to ensure that the dot product operation performed by the dot product circuitry associated with the given data block will produce the required part of the at least one result data element that is to be used to update the value of the given data block. Hence, by appropriate design of the input manipulation circuitry, it is possible to accommodate the use of multiple variants of the complex valued outer product instruction whilst using the same underlying computational hardware.

The input manipulation circuitry can be arranged in a variety of ways, but in one example implementation the input manipulation circuitry associated with each given data block is arranged to generate a plurality of candidate variants of the real parts and the imaginary parts of the at least one source data element, and further comprises multiplexer circuitry controlled, in dependence on the variant of the complex valued outer product instruction being executed, to select which of the candidate variants to provide to the dot product circuitry associated with the given data block. This can provide a particularly efficient implementation.

In one example implementation, the plurality of variants of the complex valued outer product instruction comprises a non-conjugated variant where the complex numbers forming the source data elements of both the first source operand and the second operand are used when performing the outer product operation, and at least one conjugated variant where a conjugate of the complex numbers forming the source data elements of at least one of the first source operand and the second source operand are to be used when performing the outer product operation. As will be understood by those of ordinary skill in the art, when forming a conjugate of a complex number, the sign of the imaginary part of that complex number is reversed. The use of conjugated versions of complex numbers can be useful in a variety of applications, for example communication systems data processing, and hence it is useful to support such variants of the complex valued outer product instruction. Through appropriate configuration of the input manipulation circuitry, such conjugated variants of the complex valued outer product instruction can readily be accommodated, reusing the same underlying computational hardware.

Whilst in one example implementation, one such conjugated variant may cause conjugates of the complex numbers forming the source data elements of both source operands to be used, in another example implementation one such conjugated variant may cause conjugates of the complex numbers forming the source data elements of one source operand to be used, whilst the complex numbers forming the source data elements of the other source operand are used in their original form.

As another example of different variants of the complex valued outer product instruction that may be supported, such variants may comprise an accumulating variant where each real part and each imaginary part of each generated result data element is to be added to a current value of the associated data block to form an updated value for the associated data block, and a subtracting variant where each real part and each imaginary part of each generated result data element is to be subtracted from a current value of the associated data block to form an updated value for the associated data block. Again, by appropriate configuration of the input manipulation circuitry, it is possible to accommodate both of these variants using the same underlying computational hardware.

As mentioned earlier, in one example implementation, the input manipulation circuitry associated with the given data block may be arranged to operate on the at least one source data element of only one of the first source operand and the second source operand to be used by the dot product circuitry associated with the given data block. This can result in a particularly efficient and low cost solution, whilst still allowing a number of different variants of the complex valued outer product instruction to be supported.

In one example implementation, the technique described herein may also be used to support the performance of sum of outer products operations on complex numbers (where the number of bits forming each source data element is less than the number of bits forming each result data element). In particular, the complex valued outer product instruction (or at least one variant thereof) may take the form of a complex valued sum of outer products instruction. When executing such an instruction, real parts of multiple result data elements have a same associated data block within the two-dimensional array of data blocks, and the processing circuitry is configured to combine those real parts of multiple result data elements in order to update the value of the same associated data block. Similarly, imaginary parts of multiple result data elements have a further same associated data block within the two-dimensional array of data blocks, and the processing circuitry is configured to combine those imaginary parts of multiple result data elements in order to update the value of the further same associated data block.

In some example implementations, hardware already provided for handling outer product operations in respect of vectors of real numbers can be reused to support outer product operations in respect of vectors of complex numbers. For example, the processing circuitry may be arranged to provide a plurality of multiplier-based circuits that, in response to a real number outer product instruction specifying a first vector of real numbers and a second vector of real numbers, are used to perform a real number outer product operation using the real numbers of the first vector and the second vector, such that each multiplier-based circuit produces one real number result data element within a matrix of real number result data elements produced when performing the real number outer product operation. The dot product circuitry referred to earlier that is associated with each data block in the given two-dimensional array of data blocks, i.e. the dot product circuitry that is used when executing complex-valued outer product instructions, may be arranged to re-use multiple multiplier-based circuits of the plurality of multiplier-based circuits, along with combinational circuitry to combine outputs from those multiple multiplier-based circuits, in order to produce the required part of the at least one result data element that is to be used to update the value of that data block. In one particular example implementation, such circuits can be reconfigured on the fly to deal with either real number outer product operations or complex number outer product operations as required. Hence, the same underlying hardware can be used to perform outer product operations on both real numbers or complex numbers, with in each case the results being stored into a two-dimensional array of data blocks, resulting in a particularly efficient and flexible implementation.

The form of the multiplier-based circuits that are reused in order to perform the required functionality when executing complex-valued outer product instructions may take a variety of forms. For example, the multiplier-based circuits may take the form of multiply-add circuits used when performing real valued outer product operations, and pairs of those multiply-add circuits can be used in combination to form the dot product circuitry used when performing complex valued outer product operations. Similarly, dot-product-accumulate circuits may be used when performing real-valued sum of outer products operations, and pairs of those dot-product-accumulate circuits can be used in combination to form the dot product circuitry required when performing complex valued sum of outer products operations.

If desired, then in accordance with one example implementation predication may be used in respect of one or more of the source operands. In particular, the complex valued outer product instruction may comprise at least one predicate operand to enable one or more source data elements to be identified as being excluded from the outer product operation. Whilst it may be possible in some implementations to only provide a predicate operand for one of the source operands, in one example implementation a separate predicate operand is provided for each source operand, thereby allowing one or more source data elements in either or both of the source operands to be excluded from the outer product operation.

Each predicate operand can take a variety of forms, and in one example implementation may comprise a plurality of bits, where each bit is associated with one of the source data elements in a corresponding source operand, and is used to identify whether that data element should be subjected to the outer product operation or not. There are a variety of ways in which any data elements to be excluded can be handled. For example, performance of the operation involving that data element could be inhibited, or alternatively the operation may be performed, but any result generated based on that data element is then not used to update the corresponding data block in the two-dimensional array.

Particular example implementations will now be described with reference to the figures.

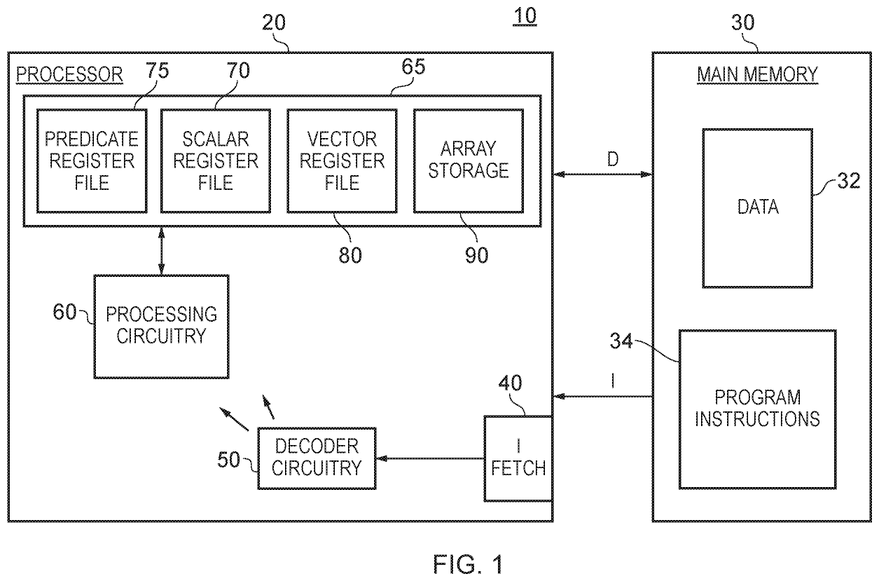

FIG. 1 schematically illustrates a data processing system 10 comprising a processor 20 coupled to a memory 30 storing data values 32 and program instructions 34. The processor 20 includes an instruction fetch unit 40 for fetching program instructions 34 from the memory 30 and supplying the fetched program instructions to instruction decoder circuitry 50. The decoder circuitry 50 decodes the fetched program instructions and generates control signals to control processing circuitry 60 to perform processing operations upon data values held within storage elements of register storage 65 as specified by the decoded vector instructions. As shown in FIG. 1, the register storage 65 may be formed of multiple different blocks. For example, a scalar register file 70 may be provided that comprises a plurality of scalar registers that can be specified by instructions, and similarly a vector register file 80 may be provided that comprises a plurality of vector registers that can be specified by instructions.

As also shown in FIG. 1, the processor 20 can access an array storage 90. In the example shown in FIG. 1, the array storage 90 is provided as part of the processor 20, but this is not a requirement. In various examples, the array storage can be implemented as any one or more of the following: architecturally-addressable registers; non-architecturally-addressable registers; a scratchpad memory; and a cache.

The processing circuitry 60 may in one example implementation comprise both vector processing circuitry and scalar processing circuitry. A general distinction between scalar processing and vector processing is as follows. Vector processing may involve applying a single vector processing instruction to data elements of a data vector having a plurality of data elements at respective positions in the data vector. The processing circuitry may also perform vector processing to perform operations on a plurality of vectors within a two dimensional array of data elements (which may also be referred to as a sub-array) stored within the array storage 90. Scalar processing operates on, effectively, single data elements rather than on data vectors. Vector processing can be useful in instances where processing operations are carried out on many different instances of the data to be processed. In a vector processing arrangement, a single instruction can be applied to multiple data elements (of a data vector) at the same time. This can improve the efficiency and throughput of data processing compared to scalar processing.

The processor 20 may be arranged to process two dimensional arrays of data elements stored in the array storage 90. The two-dimensional arrays may, in at least some examples, be accessed as one-dimensional vectors of data elements in multiple directions. In one example implementation, the array storage 90 may be arranged to store one or more two dimensional arrays of data elements, and each two dimensional array of data elements may form a square array portion of a larger or even higher-dimensioned array of data elements in memory.

The register storage 65 also includes a predicate register file 75. This stores predicate information (e.g. masks) for use in data processing operations (e.g. to mask out certain data elements of a vector so that they are excluded from a particular processing operation).

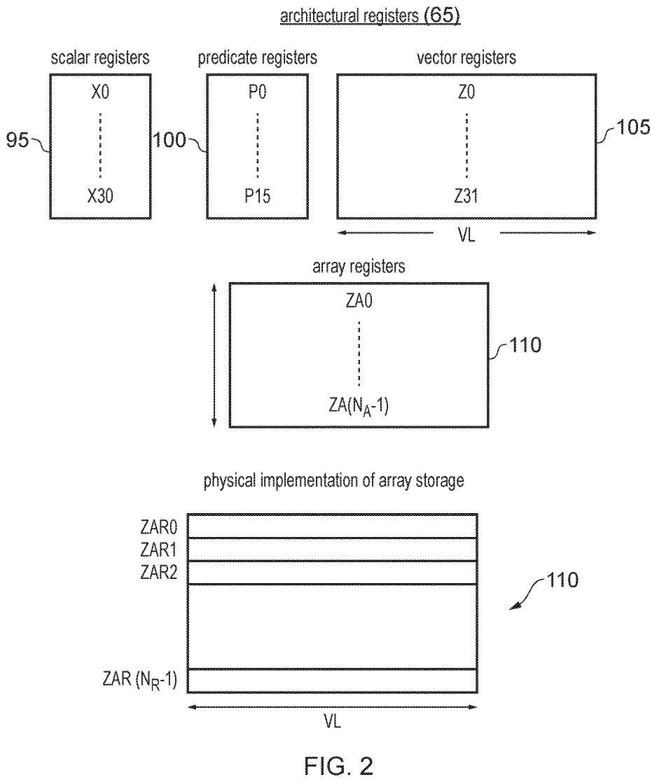

FIG. 2 shows an example of the architectural registers 65 of the processor 20 that may be provided in one example implementation. The architectural registers (as defined in the instruction set architecture (ISA)) may include a set of scalar registers 95 (labelled X0 to X30 in this example) which act as general purpose registers for processing operations performed by scalar processing circuitry within the processing circuitry 60. Also provided is a set of predicate registers 100 for storing predicate information, for example 16 registers P0-P15 in this example.

Also, the architectural registers available for selection by program instructions in the ISA supported by the decoder 50 may include a certain number of vector registers 105 (labelled Z0-Z31 in this example). Of course, it is not essential to provide the number of scalar, predicate and/or vector registers shown in FIG. 2, and other examples may provide a different number of registers specifiable by program instructions. Each vector register may store a vector operand comprising a variable number of data elements, where each data element may represent an independent data value. In response to vector processing (SIMD) instructions, the processing circuitry may perform vector processing on vector operands stored in the registers to generate results. For example, the vector processing may include lane-by-lane operations where a corresponding operation is performed on each lane of elements in one or more operand vectors to generate corresponding results for elements of a result vector. When performing vector or SIMD processing, each vector register may have a certain vector length VL where the vector length refers to the number of bits in a given vector register. The vector length VL used in vector processing mode may be fixed for a given hardware implementation or could be variable. The ISA supported by the processor 20 may support variable vector lengths so that different processor implementations may choose to implement different sized vector registers but the ISA may be vector length agnostic so that the instructions are designed so that code can function correctly regardless of the particular vector length implemented on a given CPU executing that program.

The vector registers Z0-Z31 may also serve as operand registers for storing the vector operands which provide the inputs to processing and accumulate operations performed by the processing circuitry 60 on two dimensional arrays of data elements stored within the array storage 90.

As shown in FIG. 2, the architectural registers also include a certain number NA of array registers 110 forming the earlier-mentioned array storage 90, ZA0-ZA(NA−1). Each array register can be seen as a set of register storage for storing a single 2D array of data elements, e.g. the result of a processing and accumulate operation. However, processing and accumulate operations may not be the only operations which can use the array registers. The array registers could also be used to store square arrays while performing transposition of the row/column direction of an array structure in memory. When a program instruction references one of the array registers 110, it is referenced as a single entity using an array identifier ZAi, but some types of instructions (e.g. data transfer instructions) may also select a sub-portion of the array by defining an index value which selects a part of the array (e.g. one horizontal/vertical group of elements).

In practice the physical implementation of the register storage corresponding to the array registers may comprise a certain number NR of array vector registers, ZARO-ZAR (NR-1), as also shown in FIG. 2. The array vector registers ZAR forming the array register storage 110 may be a distinct set of registers from the vector registers Z0-Z31 used for SIMD processing and vector inputs to array processing. Each of the array vector registers ZAR may have the vector length VL, so each array vector register ZAR may store a 1D vector of length VL, which may be partitioned logically into a variable number of data elements. For example, if VL is 512 bits then this could be a set of 64 8-bit elements, 32 16-bit elements, 16 32-bit elements, 8 64-bit elements or 4 128-bit elements, for example. It will be appreciated that not all of these options would need to be supported in a given implementation. By supporting variable element size this provides flexibility to handle calculations involving data structures of different precision. To represent a 2D array of data, a group of array vector registers ZARO-ZAR (NR-1) can be logically considered as a single entity assigned a given one of the array register identifiers ZA0-ZA(NA−1), so that the 2D array is formed with the elements extending within a single vector register corresponding to one dimension of the array and the elements in the other dimension of the array striped across multiple vector registers.

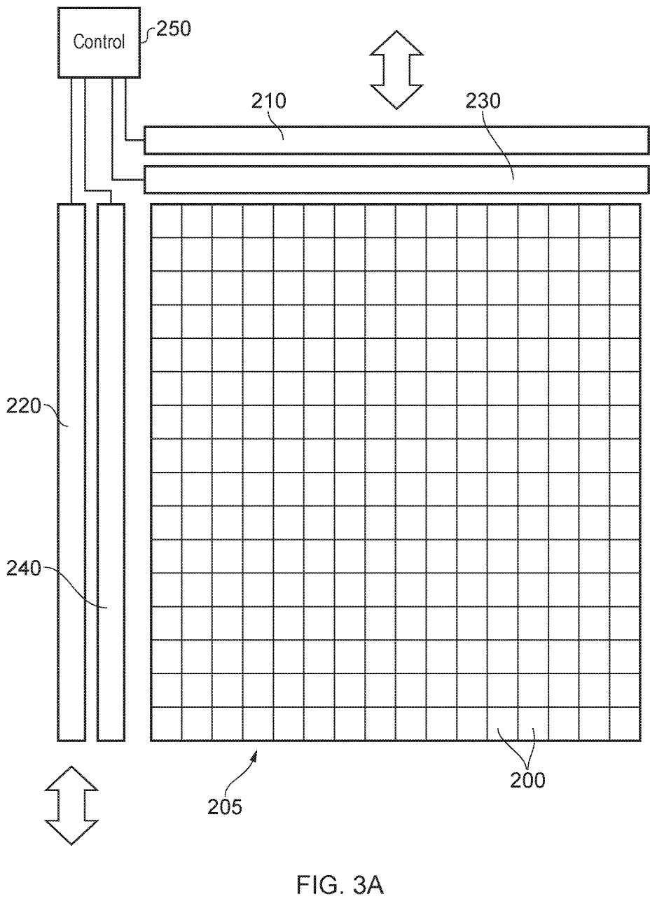

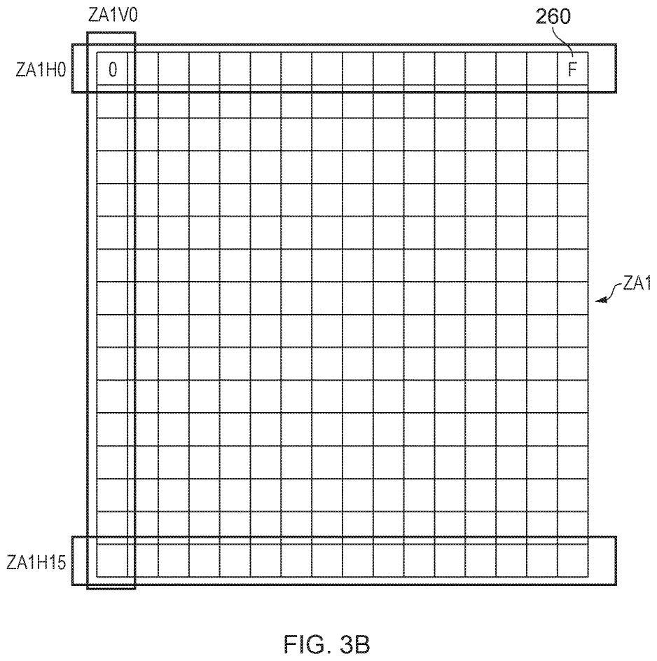

As discussed above, the processing circuitry 60 is arranged, under control of instructions decoded by decoder circuitry 50, to access the scalar registers 70, the vector register 80 and/or the array storage 90. Further details of this latter arrangement will now be described with reference FIG. 3A, which merely provides one illustrative example of how the array storage may be accessed, in particular considering access to a square 2D array within the array storage.

In the illustrated example, a square 2D array within the array storage 90 is arranged as an array 205 of n×n storage elements/locations 200, where n is an integer greater than 1. In the present example, n is 16 which implies that the granularity of access to the storage locations 200 is 1/16th of the total storage of the 2D array, in either horizontal or vertical array directions.

From the point of view of the processing circuitry, the array of n×n locations are accessible as n linear (one-dimensional) vectors in a first direction (for example, a horizontal direction as drawn) and n linear vectors in a second array direction (for example, a vertical direction as drawn). Hence, the n×n storage locations are accessible, from the point of view of the processing circuitry 60, as 2n linear vectors, each of n data elements.

The array of storage locations 200 is accessible by access circuitry 210, 220, column selection circuitry 230 and row selection circuitry 240, under the control of control circuitry 250 in communication with at least the processing circuitry 60 and optionally with the decoder circuitry 50.

With reference to FIG. 3B, the n linear vectors in the first direction (a horizontal or “H” direction as drawn), in the case of an example square 2D array designated as “ZA1” (noting that as discussed below, there could be more than one such 2D array provided within the array storage 90, for example ZA0, ZA1, ZA2 and so on) are each of 16 data elements 0 . . . . F (in hexadecimal notation) and may be referenced in this example as ZA1H0 . . . ZA1H15. The same underlying data, stored in the 256 entries (16×16 entries) of the array storage 90 ZA1 of FIG. 3B, may instead be referenced in the second direction (a vertical or “V” direction as drawn) as ZA1V0 . . . ZA1V15. Note that, for example, a data element 260 is referenced as item F of ZA1H0 but item 0 of ZA1V15. Note that the use of “H” and “V” does not imply any spatial or physical layout requirement relating to the storage of the data elements making up the array storage 90, nor does it have any relevance to whether the 2D arrays within the array storage store row or column data in any example application.

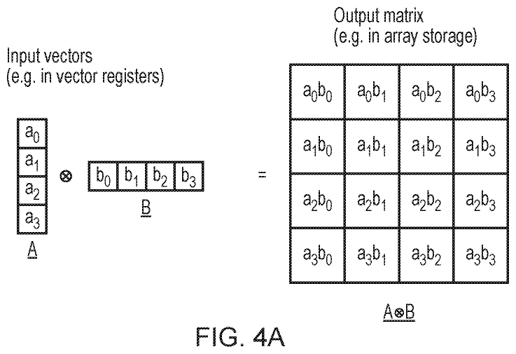

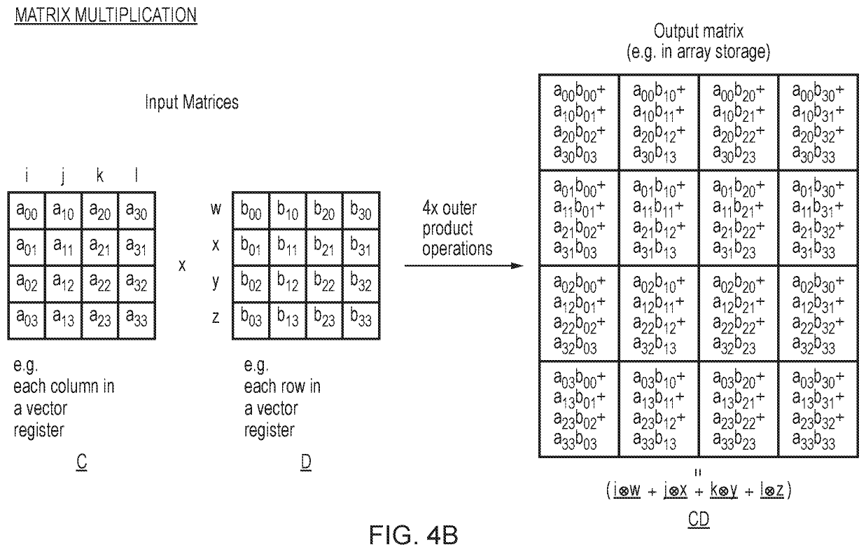

FIG. 4A illustrates an outer product operation. The outer product operation takes, as inputs, two vectors A and B, which may be stored in the vector register file as discussed above. The result of the outer product operation is a matrix (e.g. a 2D array) A⊗B. As shown in the figure, each data element in the output matrix is determined by multiplying together corresponding data elements in each input vector—for example, the top-left element in the result matrix is calculated by multiplying together element a₀ of vector A and element b₀ of vector B. In populating the result matrix, each data element in vector A is multiplied by each data element in vector B; hence, the result of calculating an outer product operation of a vector of n elements and a vector of m elements is an n×m matrix.

FIG. 4B illustrates a matrix multiplication operation. In particular, FIG. 4B shows an operation involving multiplying together two matrices C and D (which could, for example, be stored in vector registers (e.g. one row or one column being held in each register) or in array storage circuitry) to generate a matrix CD. As can be seen from the figure, the result of multiplying together two n×n matrices is an n×n matrix (more generally, an n×k matrix multiplied by an k×m matrix will result in an n×m matrix).

There are several ways to calculate the elements of the output matrix CD, but the technique that is typically employed by processors is to perform multiple outer product operations and accumulate (add) together the results. For example, to perform the matrix multiplication illustrated in FIG. 4B, processing circuitry may first calculate the outer product of the left-most column, i, of matrix A and the top row, w, of matrix B to generate 16 outer product results and populate a 4×4 array in the array storage with the outer product results. The processing circuitry may then calculate an outer product of the next column, j, of matrix A with the next row, x, of D, to generate another 16 outer product results which are added to the outer product results already stored in the array. This process can then be repeated for the last two pairs of vectors (k⊗y and l⊗z), to generate the final result CD.

Hence, it can be seen that a matrix multiplication can be carried out by performing multiple outer product operations and accumulating the results—for example, this could be by performing one or more multiple-outer-product instructions. It should be noted that the order in which the pairs of vectors are multiplied together is not limited to the order described above—the outer products can be calculated in any order. In addition, it is not necessary to perform the outer product operations one after the other.

In accordance with the techniques described herein, an apparatus and method are provided that are able to perform outer product operations on vectors of complex numbers. As noted earlier, there are many computational tasks where complex-valued arithmetic is required, for example in digital signal processing (DSP) algorithms, in communication infrastructure 5G applications, in high performance computing (HPC) applications, etc. Often multiplication of complex numbers is required, and given the demands on computational resources typically needed to perform such complex valued multiplication operations, it would be desirable to provide techniques for accelerating such multiplication operations, to thereby improve performance/throughput. By supporting the performance of outer product operations using complex numbers, this can significantly improve performance, for example in situations where large volumes of complex valued multiplication operations are required.

In accordance with the techniques described herein, one or more variants of a complex valued outer product instruction are provided for execution by a data processing apparatus. Such a complex valued outer product instruction specifies first and second source vector operands that each comprise a plurality of source data elements, where each source data element is a complex number formed of a real part and an imaginary part. Further, the complex valued outer product instruction specifies as a destination operand a two-dimensional array of data blocks within the array storage 90. In response to such a complex valued outer product instruction, the processing circuitry 60 performs an outer product operation using the source data elements of both source operands, in order to generate a plurality of result data elements. Each result data element is a complex number formed of a real part and an imaginary part, and each real part and each imaginary part of each result data element is associated with one of the data blocks in the specified two-dimensional array of data blocks, and is used to update a value of that associated data block. For instance, accumulation or subtraction variants can be specified, causing each real part and each imaginary part of each result data element to be added to, or subtracted from, the value currently held in the associated data block.

Whilst in a first variant of the complex valued outer product instruction, a normal outer product operation may be specified, resulting in a one-to-one correspondence between each part of each result data element and an associated data block in the two-dimensional array, in accordance with an alternative or additional variant of the complex valued outer product instruction, a sum of outer products operation may be specified by that instruction, and in that event the real parts, and similarly the imaginary parts, of multiple result data elements may be associated with the same data block within the two-dimensional array and used to update the value in that data block.

By specifying a single instruction whose execution causes the processing circuitry to perform an outer product operation on vectors of complex numbers, significant performance improvements can be realised. Firstly, prior to the present technique it would typically have been necessary to execute multiple vector instructions to seek to perform multiplication operations on vectors of complex numbers. Given the limitation on instruction encoding space, it is important to use instruction encoding space wisely. The format of the instruction encoding and the functionality represented by each instruction may be defined according to an instruction set architecture (ISA). The ISA represents the agreed framework between the hardware manufacturer who manufactures the processing hardware for a given processor implementation and the software developer who writes code to execute on that hardware, so that code written according to the ISA will function correctly on hardware supporting ISA.

When designing an ISA, there can be a significant design challenge in determining the set of processing operations to be supported in the ISA and the encoding of the instructions to represent those operations. In principle there may be a wide variety of different types of processing operation which may be useful to the support for some program applications, but within the encoding space available it may not be possible to represent every possible data processing operation which could be useful to a particular programmer. There may be a restriction on the number of bits available for encoding each instruction, because increasing the instruction bit width would incur additional circuit area and power consumption each time the instruction is stored anywhere within the processor or is transferred over wired processing paths between logic elements. To limit hardware and power costs, an instruction bit width may be selected which, when taking account of the need to encode operand values through register specifiers and/or immediate values, leaves an opcode space which is insufficient to represent every possible data processing operation which could be desired. Therefore, a design decision would need to be made as to which subset of operations are the most important to support, and any operations which cannot be supported in a single instruction would then have to be performed using sets of multiple instructions with equivalent functionality when executed together. Hence, the design decisions made by the ISA designer when planning the instruction encoding of the ISA may have a significant effect on the real world performance achieved by processing hardware when executing a particular program, depending upon whether the instructions are available to support the operations desired.

Therefore, any techniques which can improve the efficiency with which a given set of operations can be represented within the encoding space of the instruction set can be extremely valuable in improving overall performance when that ISA is subsequently implemented on a hardware device. If an encoding efficiency improvement can be provided which allows even a single bit of encoding space to be saved so that it can be reused for other purposes (e.g. providing an additional opcode bit and therefore doubling the number of different processing operations which can be represented), then this will be extremely valuable because the increased number of processing operation types supported can then be exploited by programmers so that more operations can be performed in a single instruction to improve processing performance. Hence, gains in encoding efficiency, even if apparently small and resulting in only a single bit of additional encoding space becoming available, in practice have a massive effect on the performance achieved by processing devices. It has been found to be highly beneficial in terms of encoding efficiency to provide a complex valued outer product instruction within the ISA. Further, the provision of such a complex valued outer product instruction within the ISA can give rise to significant performance benefits, due to the reduction in the number of instructions that need to be executed to perform the required functionality.

Secondly, in addition to the above benefits resulting from the use of a single instruction, the instruction defined herein also allows an outer product operation to be performed in respect of vectors of complex numbers, with the results being accumulated into a two-dimensional array. This can enable an efficient use of processing resources, and provides a very flexible approach. For example, such an approach readily enables accumulation or subtraction operations to be incorporated when performing the computations. This can be very beneficial in many example scenarios where high volumes of multiplication operations performed in respect of complex numbers are required. For example, by using the same destination operand (i.e. the same two-dimensional array of data blocks) for multiple instances of the complex valued outer product instruction, this can provide a particularly efficient mechanism for performing matrix multiplication operations using vectors of complex numbers.

In accordance with the techniques described herein, within each of the source vector operands the real and imaginary parts of the various source data elements are interleaved with respect to each other, which allows the source data elements required for the various computational blocks within the processing circuitry to be logically grouped for provision to those computational blocks, thereby resulting in a particularly efficient implementation. Furthermore, within at least one dimension of the two-dimensional array forming the destination operand, the real parts and the imaginary parts of multiple result data elements are associated with the data blocks such that the real parts of those result data elements are interleaved with the imaginary parts of those result data elements, which again can further improve the efficiency of the implementation by reducing routing complexity between the computational blocks and the associated data blocks within the two-dimensional array.

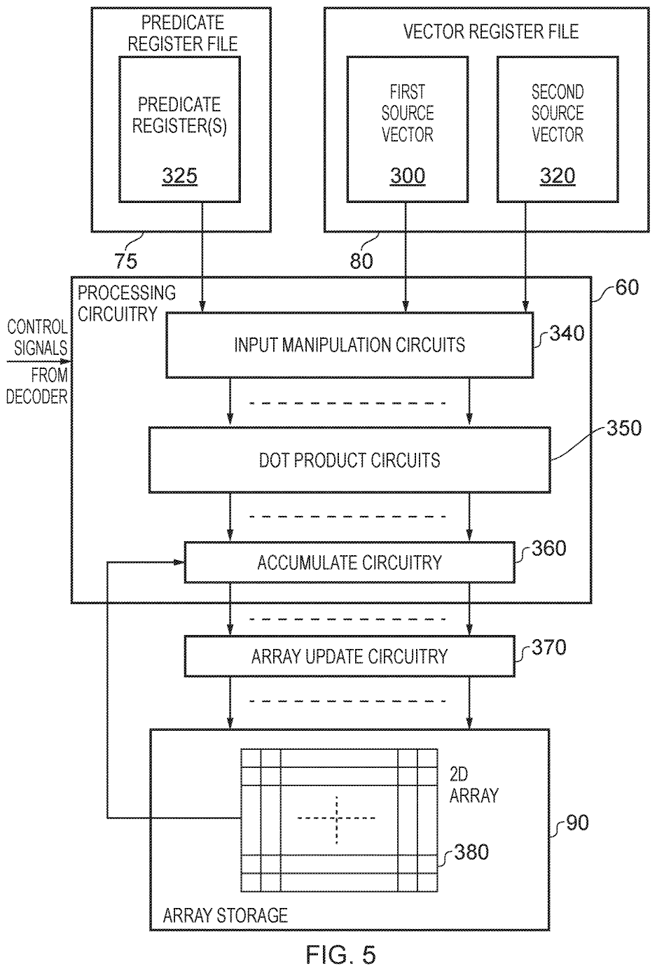

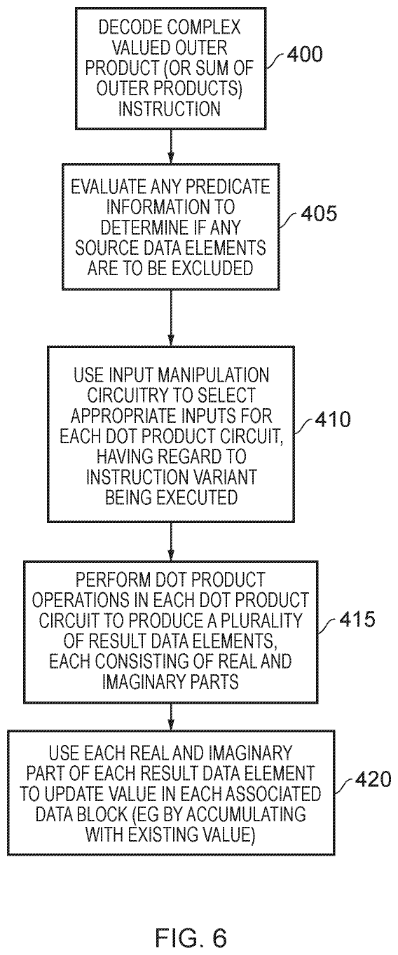

The block diagram of FIG. 5 and the flow diagram of FIG. 6 will now be used to illustrate the operations performed by the processing circuitry when executing a complex valued outer product instruction, in accordance with one particular example implementation. As shown in FIG. 5, the vector register file 80 provides a plurality of vector registers that can be used to store vectors of data elements. The complex valued outer product instruction is arranged to identify a first source vector operand 300 and a second source vector operand 320, where each source vector operand comprises multiple source data elements, and each source data element is a complex number formed of real and imaginary parts. As discussed earlier, in some implementations the complex valued outer product instruction may also be able to specify one or more predicate registers 325 within the predicate register file 75, each specified predicate register being associated with one of the source vector operands and being used to identify whether any of the data elements in that source vector operand is to be excluded from the data processing operations to be performed.

As illustrated in FIG. 6, when a complex valued outer product instruction, or complex valued sum of outer products instruction, is encountered, it is decoded at step 400 by the decoder circuitry 50 in order to produce control signals to issue to the processing circuitry 60. Those control signals will identify the type of outer product operation to be performed, and also identify the vector registers 300, 320 providing the source data elements of the first and second source operands, and any predicate registers 325 providing predicate information. At step 405, the predicate information is evaluated in order to determine if any of the source data elements are to be excluded from the outer product operation (or sum of outer products operation).

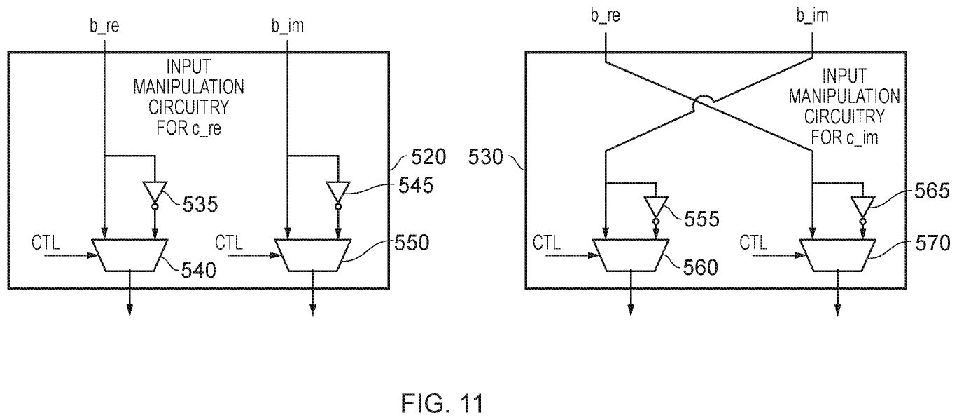

At step 410, the input manipulation circuitry 340 provided in association with the processing circuitry 60 is used to select the appropriate inputs for each of the dot product circuits 350 provided by the processing circuitry 60. This selection is done having regard to the variant of outer product instruction to be executed. The input manipulation circuitry used in one example implementation will be discussed later with reference to FIG. 11, but in one example implementation is able to invert the real and/or imaginary parts of one or more source data elements, and also to reverse the order of the real and imaginary parts of one or more source data elements, as required, in order to ensure that the dot product circuits 350 then produce the appropriate result data elements having regard to the type of outer product operation being performed.

At step 415, the dot product circuits 350 are then used to perform dot product operations, in order to produce a plurality of result data elements, each result data element consisting of real and imaginary parts. If any predicate information indicates that one or more source data elements are not to be subjected to the operation, then either the dot product circuits using those excluded source data elements can be arranged not to perform the dot product operations that would use those excluded source data elements, or otherwise may be arranged to operate as normal but with the result data elements based on those excluded source data elements then being inhibited from updating the contents of the two-dimensional array 380 within the array storage 90.

Thereafter, at step 420, each real and imaginary part of each result data element (other than any that are excluded by virtue of the predicate information) are used to update the value in each associated data block of the two-dimensional array 380. In one example implementation this is achieved by use of the accumulate circuitry 360, which accumulates the result data elements with the existing values in the two-dimensional array in order to produce updated values for storing within the two-dimensional array 380 using the array update circuitry 370. If a variant of the complex valued outer product instruction is used that requires the results to be subtracted from the existing contents of the two-dimensional array, then in one example implementation this is achieved by appropriate manipulation of the inputs by the input manipulation circuits 340 prior to providing those inputs to the dot product circuits 350, so that the result data elements produced by the dot product circuits 350 can then be added by the accumulate circuitry 360 to the existing values within the two-dimensional array in order to produce updated values that correspond to those that would be produced by the specified subtraction operation.

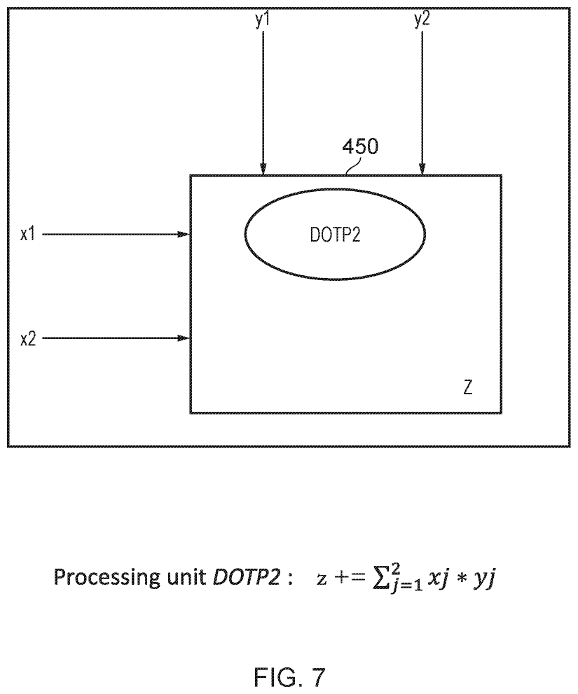

In one example implementation, multiple instances of dot product circuitry is used by the processing circuitry to perform the complex valued outer product operation. A two-way dot product circuit 450 is shown schematically in FIG. 7, and performs the computation also illustrated in FIG. 7. As can be seen, the value in the destination data block Z is updated by adding x1*y1 and x2*y2 to it (note that accumulation circuitry (not explicitly shown in FIG. 7) will be used to accumulate the output of the two-way dot product circuit with the existing data value of data block Z). To reduce complexity in the following figures, such accumulation circuitry has also been omitted from those figures, but it is understood will be provided in association with the various dot product circuits to perform the required accumulation of the dot product outputs with the corresponding existing data values.

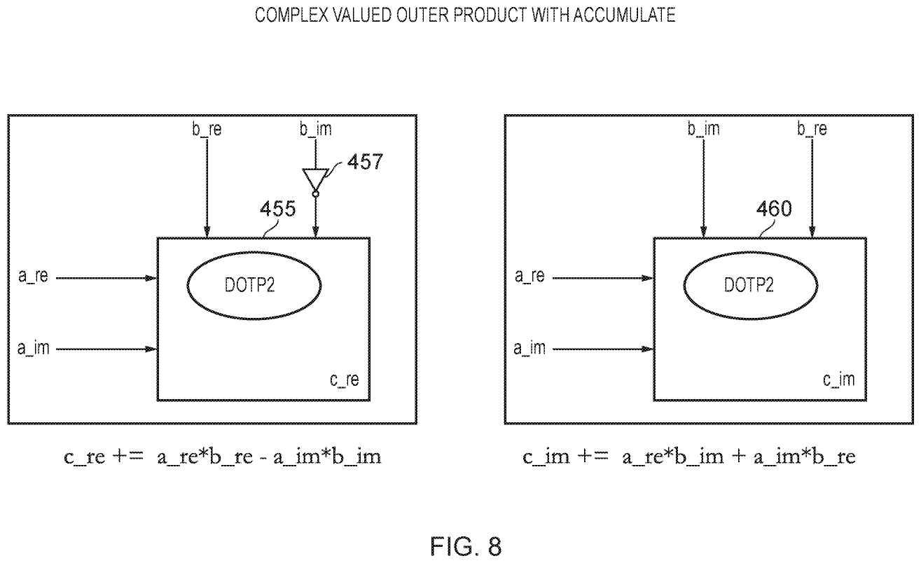

As shown in FIG. 8, a pair of such two-way dot product circuits 455, 460 can be used to generate real and imaginary parts, respectively, of a result data element “c” produced by multiplying a first complex number “a” by a second complex number “b”. As can be seen, each dot product circuit 455, 460 receives the real and imaginary parts of both complex numbers “a” and “b”. The first dot product circuit 455, by virtue of the imaginary part of the complex number “b” being inverted, produces the updated real part of the result data element “c” (c_re) by performing the computation shown below element 455 in FIG. 8. Similarly, because the dot product circuit 460 receives the real and imaginary parts of the complex number “b” in a reversed order, that dot product circuit produces the updated imaginary part of the result data element “c” (c_im) by performing the computation shown below element 460 in FIG. 8 (as noted earlier, the required accumulation circuitry is not explicitly shown in the figures). The computed real and imaginary parts of the result can hence be accumulated into respective data blocks of the two-dimensional array to update any existing real and imaginary values stored within those data blocks.

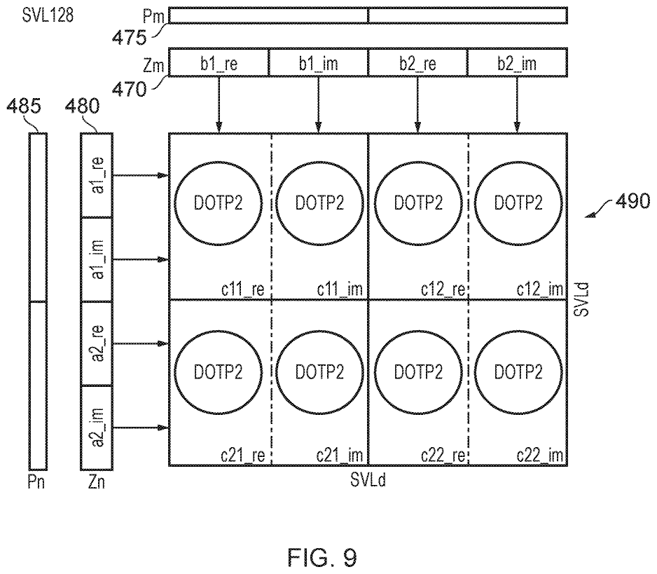

As shown schematically in FIG. 9, the dot product circuits of FIG. 8 can be replicated as required to provide computational blocks associated with each data block within the two-dimensional array 490, with each dot product circuit receiving the real and imaginary parts of one source data element of a first source vector register 470 and the real and imaginary parts of one source data element of a second source vector register 480. As shown in FIG. 9, predicate registers 475, 485 can be provided in association with each source vector register if desired, and specify predicate information for each data element. In the example shown in FIG. 9, it can be seen that each source vector contains two data elements, and hence two items of predicate information may be provided for each source vector. Further, each source data element comprises real and imaginary parts. As can be seen from FIG. 9, each of the eight dot product circuits performs a dot product operation, resulting in four updated result data elements being generated, each comprising real and imaginary parts.

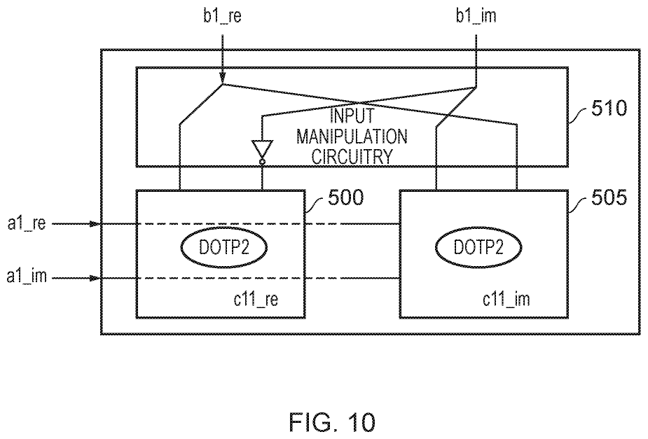

FIG. 10 schematically illustrates input manipulation circuitry 510 that may be provided in association with each pair of dot product circuits 500, 505 used to produce real and imaginary parts of a result data element for updating the values in corresponding data blocks of the two-dimensional array. In this example, the input manipulation circuitry 510 is used to perform the manipulations required to perform the computations discussed earlier with reference to FIG. 8, and accordingly the imaginary part of the second data element b1 is inverted prior to provision to the dot product circuit 500, and the real and imaginary parts of the second data element b1 are swapped prior to provision to the dot product circuit 505.

In a more general implementation, the input manipulation circuitry can be organised so that it can support the performance of a number of different variants of the complex valued outer product instruction using the same underlying dot product circuitry. One such implementation is illustrated by way of example in FIG. 11. As can be seen, the input manipulation circuitry 520 that may be provided in association with a first dot product circuit used to compute a real part of a result data element causes both original and inverted versions of the real and imaginary parts of an input data element to be produced (the inverted versions being generated using the inverters 535, 545), with the multiplexing circuits 540, 550 then choosing the appropriate real and imaginary values to pass on to the associated dot product circuit in dependence on the variant of the instruction being executed. The input manipulation circuitry 530 provided in association with a second dot product circuit in a pair of dot product circuits (this second dot product circuit being used to generate the imaginary part of a result data element) operates in a similar manner, again causing both the original and inverted versions of the real and imaginary parts of the input data element to be produced (the inverted versions being generated using the inverters 555, 565). However, in addition the ordering of the real and imaginary parts of that input data element are reversed by the input manipulation circuitry 530. As with the input manipulation circuitry 520, the input manipulation circuitry 530 then uses multiplexing circuits 560, 570 to choose the appropriate real and imaginary values to pass on to the associated dot product circuit in dependence on the variant of the instruction being executed.

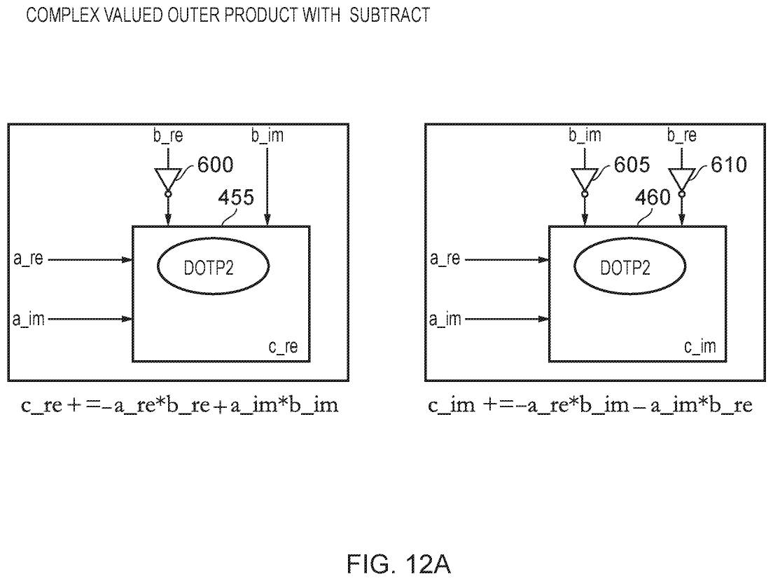

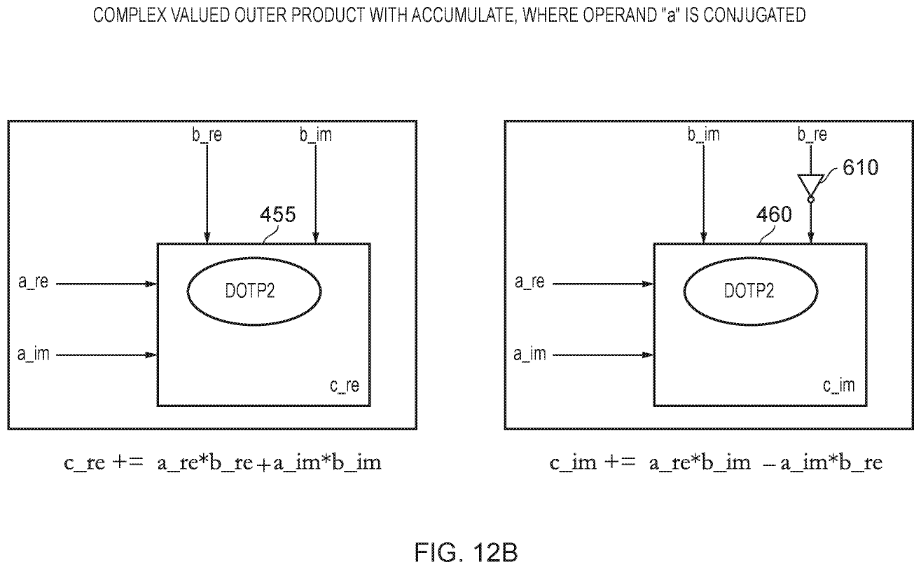

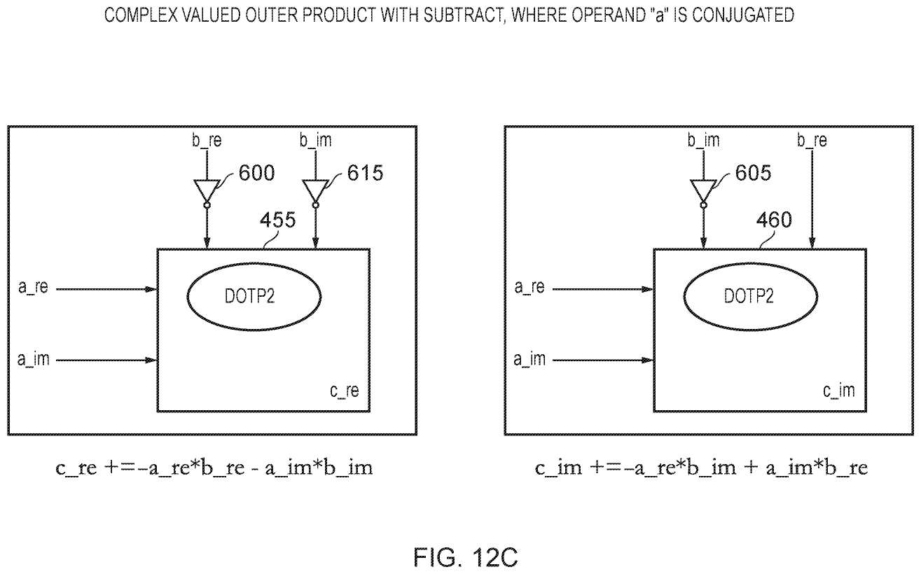

Using the input manipulation circuitry of FIG. 11, it is then possible to implement any of the instruction variants illustrated schematically with reference to FIGS. 12A to 12C, in addition to the variant discussed earlier with reference to FIG. 8. Whilst the arrangement shown in FIG. 8 allows a complex valued outer product with accumulate operation to be performed (for example when the pair of dot product circuits of FIG. 8 are replicated as shown in FIG. 9), the same pair of dot product circuits can be used, as shown in FIG. 12A, to allow a complex valued outer product with subtract operation to be performed, and in particular the dot product circuits 455, 460 will perform the computations shown below those blocks in FIG. 12A by virtue of the inversions performed by the inverters 600, 605, 610, and the swapping of the real and imaginary parts of the data element “b” prior to provision to the second dot product circuit 460.

Similarly, as shown in FIG. 12B, by using the input manipulation circuitry of FIG. 11 it is also possible to enable a complex valued outer product with accumulate operation to be performed, where the operand “a” is conjugated. As discussed earlier, the conjugate of a complex number is formed by reversing the sign of the imaginary part. The effective conjugation of the operand “a” is actually achieved in the example of FIG. 12B via appropriate manipulation of the operand “b”. In particular, as shown, the imaginary part of the operand “b” is not inverted prior to provision to the dot product circuit 455 (in contrast to the approach taken in FIG. 8) and the real part of the operand “b” is inverted by the inverter 610 prior to provision to the dot product circuit 460 (again in contrast to the approach taken in FIG. 8). As a result, the two dot product circuits 455, 460 perform the computations shown below those elements in FIG. 12B.

Further, as shown in FIG. 12C, by using the input manipulation circuitry of FIG. 11 it is also possible to enable a complex valued outer product with subtract operation to be performed, where the operand “a” is conjugated. Again, the effective conjugation of the operand “a” is actually achieved in the example of FIG. 12C via appropriate manipulation of the operand “b”. In particular, as shown, the real and imaginary parts of the operand “b” are inverted by inverters 600, 615 prior to provision to the dot product circuit 455, and the imaginary part of the operand “b” is inverted by the inverter 605 prior to provision to the dot product circuit 460. As a result, the two dot product circuits 455, 460 perform the computations shown below those elements in FIG. 12C.

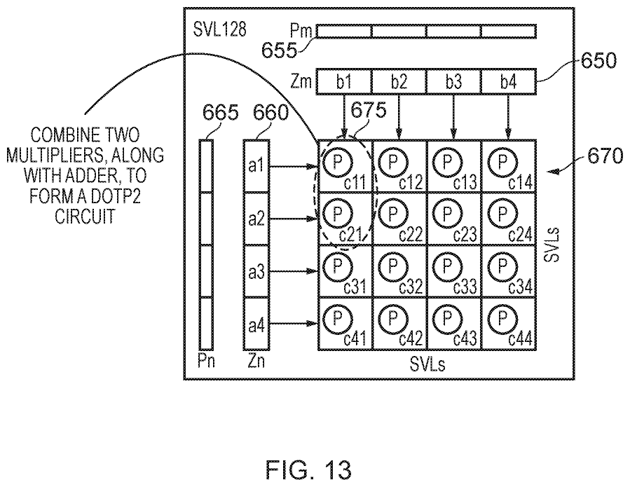

In one example implementation, each of the dot product circuits required to perform the above described operations can be implemented by reusing existing multiplier-based circuits already provided by the apparatus to support the performance of outer product operations in respect of vectors of real numbers. By way of illustrative example, FIG. 13 shows a 4×4 two-dimensional array 670 of data blocks, with a multiply-add circuit (“P”) provided in association with each data block. Two source vector operands 650, 660, each comprising four real valued data elements, can then be subjected to an outer product operation in order to produce updated values for the 4×4 two-dimensional array 670 of data blocks. Predicate registers 655, 665 can be provided in association with each source vector operand if desired and, as each of the vectors comprises four data elements, four items of predicate information may be provided within each predicate register.

As shown schematically in FIG. 13, pairs 675 of the multiply-add circuits can be used in combination, along with adder circuitry to combine the outputs of those circuits, in order to implement each two-way dot product circuit illustrated schematically in FIG. 9. By comparison of FIG. 13 with FIG. 9, it will be seen that when the same circuitry is used to implement a complex valued outer product operation, then two vectors of two complex valued data elements can be provided as inputs, instead of two vectors of four real valued data elements. This provides a particularly efficient implementation, as it allows the same underlying circuitry to be used to perform outer product operations on both vectors of real numbers and vectors of complex numbers, merely by appropriate reconfiguration of the basic circuit blocks as required.

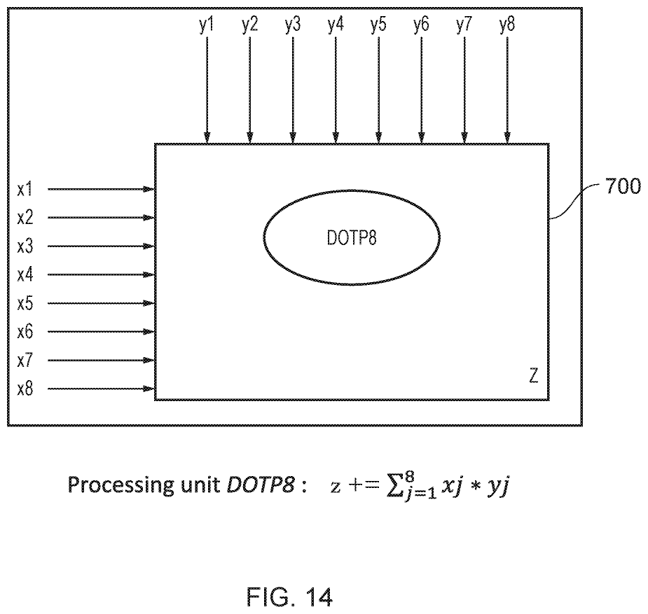

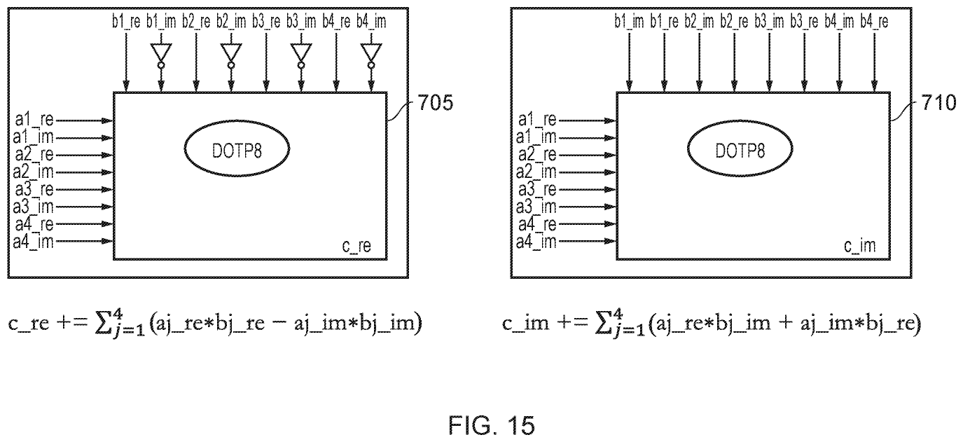

In one example implementation, the apparatus described herein can also perform sum of outer product operations in relation to vectors of complex numbers, and in particular the apparatus can be arranged to execute a complex valued sum of outer products instruction. Again, dot product circuitry can be used for this purpose. FIG. 14 illustrates an eight way dot product circuit that may be provided to perform a dot product operation in respect of two vectors of real data elements, where each vector comprises eight real data elements. A pair of such circuits can also be used, as shown in FIG. 15, to generate the real and imaginary parts of a result data element based on four data elements of a first vector operand and four data elements of a second vector operand, each of those data elements being complex numbers and hence having real and imaginary parts. Hence, a pair of eight way dot product circuits is used to compute a complex-valued four way dot product. Each of the dot product circuit 705, 710 hence performs the computation shown below those elements in FIG. 15 (in combination with accumulation circuitry which, as noted earlier, is not explicitly shown in the figures).

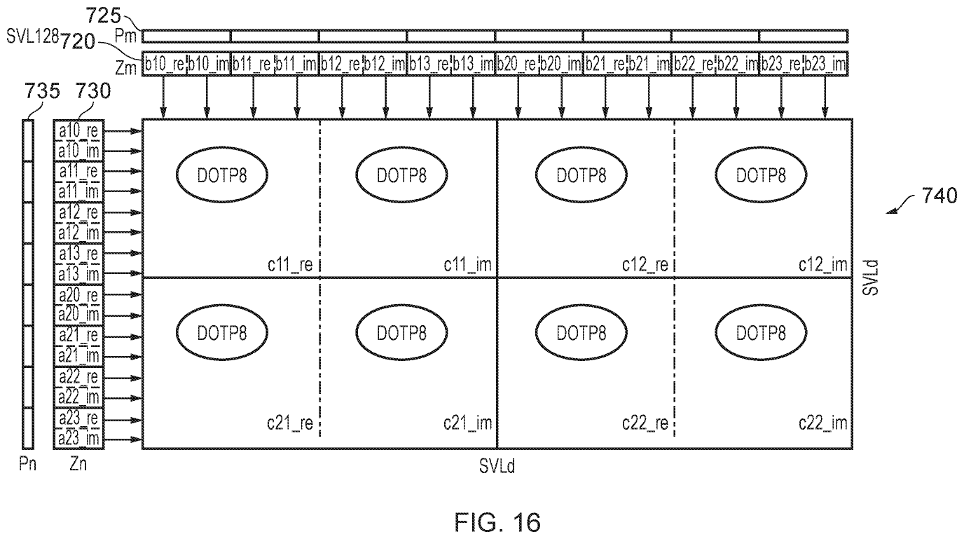

Hence, when an array of such dot product circuits are used in association with a two-dimensional array 740, such as shown in FIG. 16, a sum of outer products operation can be performed in respect of two source vector operands 720, 730 of complex valued data elements, and again predicate registers 725, 735 can be specified in association with each source vector operand if desired. In this specific example shown in FIG. 16, each source vector operand comprises eight data elements, and hence eight items of predicate information may be provided by each predicate register 725, 735. The result data elements produced can then be accumulated within the two-dimensional array 740 shown.

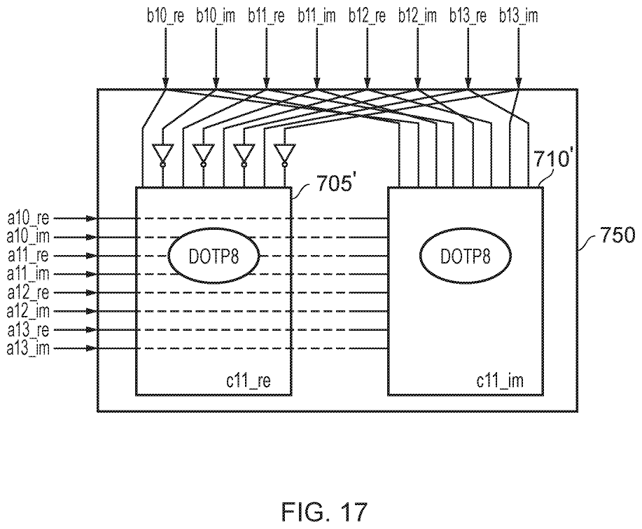

FIG. 17 schematically illustrates a block of circuitry 750, that includes two instances 705′, 710′ of the eight way dot product circuitry, along with associated input manipulation circuitry to reorder and invert the relevant parts of the source data elements of one of the source vector operands input to those dot product circuits. It will be appreciated that this circuitry can be replicated four times in order to implement the functionality shown in FIG. 16.

Whilst in the examples of FIGS. 15 to 17, it is assumed that each dot product circuit uses four data elements from each source operand, this is not a requirement and it will be appreciated that in other examples different numbers of source data elements may be consumed by each dot product circuit. In general terms, the source data element size is smaller than the result data element size when performing sum of outer products operations, and the number of complex-valued products produced is given by the ratio of the element size width of the result data elements and input data elements. In the example of FIGS. 15 to 17, the result data elements have a width four times that of the input data elements, and accordingly four complex valued results are produced.

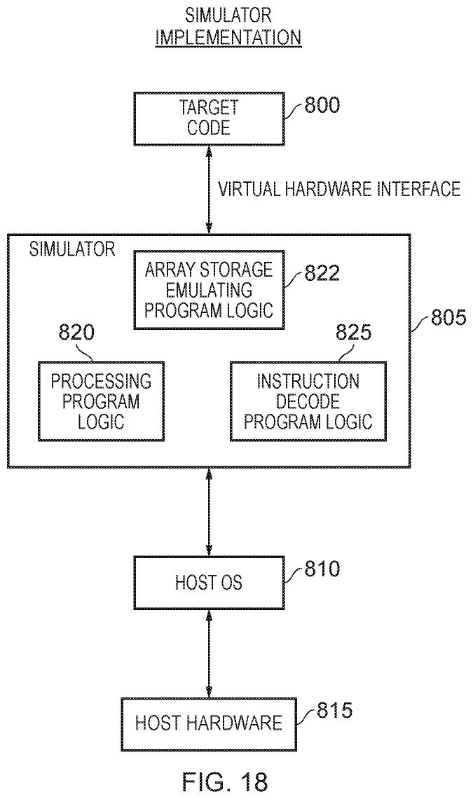

FIG. 18 illustrates a simulator implementation that may be used. Whilst the earlier described examples implement the present invention in terms of apparatus and methods for operating specific processing hardware supporting the techniques concerned, it is also possible to provide an instruction execution environment in accordance with the examples described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 815, optionally running a host operating system 810, supporting the simulator program 805. In some arrangements there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990, USENIX Conference, Pages 53 to 63.

To the extent that examples have previously been described with reference to particular hardware constructs or features, in a simulated implementation equivalent functionality may be provided by suitable software constructs or features. For example, particular circuitry may be provided in a simulated implementation as computer program logic. Similarly, memory hardware, such as register or cache, may be provided in a simulated implementation as a software data structure. Also, the physical address space used to access memory 30 in the hardware apparatus 10 could be emulated as a simulated address space which is mapped on to the virtual address space used by the host operating system 810 by the simulator 805. In arrangements where one or more of the hardware elements referenced in the previously described examples are present on the host hardware (for example host processor 815), some simulated implementations may make use of the host hardware, where suitable.

The simulator program 805 may be stored on a computer readable storage medium (which may be a non-transitory medium), and provides a virtual hardware interface (instruction execution environment) to the target code 800 (which may include applications, operating systems and a hypervisor) which is the same as the hardware interface of the hardware architecture being modelled by the simulator program 805. Thus, the program instructions of the target code 800 may be executed from within the instruction execution environment using the simulator program 805, so that a host computer 815 which does not actually have the hardware features of the apparatus 10 discussed above can emulate those features. The simulator program may include processing program logic 820 to emulate the behaviour of the processing circuitry 60, instruction decode program logic 825 to emulate the behaviour of the instruction decoder circuitry 50, and array storage emulating program logic 822 to maintain data structures to emulate the array storage 90. Hence, the techniques described herein can in the example of FIG. 18 be performed in software by the simulator program 805.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
processing circuitry to perform vector operations;
instruction decoder circuitry to decode instructions from a set of instructions to control the processing circuitry to perform the vector operations specified by the instructions; and
array storage comprising storage elements to store data blocks, the array storage being arranged to store at least one two-dimensional array of data blocks accessible to the processing circuitry when performing the vector operations;
wherein:
the set of instructions comprises a complex valued outer product instruction specifying a first source operand, a second source operand, and a destination operand, wherein each of the first source operand and the second source operand is a vector operand comprising a plurality of source data elements, each source data element is a complex number formed of a real part and an imaginary part, and the destination operand identifies a given two-dimensional array of data blocks within the array storage; and
the processing circuitry is responsive to the complex valued outer product instruction to perform an outer product operation using the source data elements of the first source operand and the source data elements of the second source operand in order to generate a plurality of result data elements, where each result data element is a complex number formed of a real part and an imaginary part, and where each real part and each imaginary part of each result data element is associated with one of the data blocks in the given two-dimensional array of data blocks and is used to update a value of that associated data block.

2. An apparatus as claimed in claim 1, wherein both the first source operand and the second source operand are configured to interleave the real parts of the plurality of source data elements and the imaginary parts of the plurality of source data elements.

3. An apparatus as claimed in claim 1, wherein within at least one dimension of the given two-dimensional array of data blocks, the real parts and the imaginary parts of multiple result data elements are associated with the data blocks such that the real parts of the multiple result data elements are interleaved with the imaginary parts of the multiple result data elements.

4. An apparatus as claimed in claim 1, wherein:
the processing circuitry comprises dot product circuitry associated with each data block in the given two-dimensional array of data blocks; and
the dot product circuitry associated with a given data block is arranged to perform a dot product operation using the real parts and the imaginary parts of at least one source data element of the first source operand and at least one source data element of the second source operand in order to produce a required part of at least one result data element that is to be used to update the value of the given data block.

5. An apparatus as claimed in claim 4, further comprising input manipulation circuitry associated with each data block in the given two-dimensional array of data blocks, wherein the input manipulation circuitry associated with the given data block is controlled in dependence on the complex valued outer product instruction to perform an input manipulation operation to adjust how the real and imaginary parts of at least one source data element are provided to the dot product circuitry associated with the given data block in order to ensure that the performance of the dot product operation produces the required part of the at least one result data element that is to be used to update the value of the given data block.

6. An apparatus as claimed in claim 5, wherein the input manipulation circuitry comprises at least one of:
inverter circuitry to invert the value of at least one part of the at least one source data element; and
reordering circuitry to swap an ordering of real and imaginary parts of the at least one source data element.

7. An apparatus as claimed in claim 5, wherein a plurality of variants of the complex valued outer product instruction are supported by the apparatus, and the input manipulation operation performed by the input manipulation circuitry associated with the given data block is dependent on the variant of the complex valued outer product instruction being executed, so as to ensure that the dot product operation performed by the dot product circuitry associated with the given data block will produce the required part of the at least one result data element that is to be used to update the value of the given data block.

8. An apparatus as claimed in claim 7, wherein the input manipulation circuitry associated with the given data block is arranged to generate a plurality of candidate variants of the real parts and the imaginary parts of the at least one source data element, and the input manipulation circuitry further comprises multiplexer circuitry controlled, in dependence on the variant of the complex valued outer product instruction being executed, to select which of the candidate variants to provide to the dot product circuitry associated with the given data block.

9. An apparatus as claimed in claim 7, wherein the plurality of variants of the complex valued outer product instruction comprises a non-conjugated variant where the complex numbers forming the source data elements of both the first source operand and the second operand are used when performing the outer product operation, and at least one conjugated variant where a conjugate of the complex numbers forming the source data elements of at least one of the first source operand and the second source operand are to be used when performing the outer product operation.

10. An apparatus as claimed in claim 7, wherein the plurality of variants of the complex valued outer product instruction comprises an accumulating variant where each real part and each imaginary part of each generated result data element is to be added to a current value of the associated data block to form an updated value for the associated data block, and a subtracting variant where each real part and each imaginary part of each generated result data element is to be subtracted from a current value of the associated data block to form an updated value for the associated data block.

11. An apparatus as claimed in claim 5, wherein the input manipulation circuitry associated with the given data block is arranged to operate on the at least one source data element of only one of the first source operand and the second source operand to be used by the dot product circuitry associated with the given data block.

12. An apparatus as claimed in claim 1, wherein:
the complex valued outer product instruction comprises a complex valued sum of outer products instruction;
real parts of multiple result data elements have a same associated data block within the two-dimensional array of data blocks, and the processing circuitry is configured to combine those real parts of multiple result data elements in order to update the value of the same associated data block; and
imaginary parts of multiple result data elements have a further same associated data block within the two-dimensional array of data blocks, and the processing circuitry is configured to combine those imaginary parts of multiple result data elements in order to update the value of the further same associated data block.

13. An apparatus as claimed in claim 1, wherein:
the processing circuitry is arranged to provide a plurality of multiplier-based circuits arranged, in response to a real number outer product instruction specifying a first vector of real numbers and a second vector of real numbers, to perform a real number outer product operation using the real numbers of the first vector and the second vector, such that each multiplier-based circuit produces one real number result data element within a matrix of real number result data elements produced when performing the real number outer product operation; and
the dot product circuitry associated with each data block in the given two-dimensional array of data blocks is arranged in response to the complex valued outer product instruction to reuse multiple multiplier-based circuits of the plurality of multiplier-based circuits, along with combinational circuitry to combine outputs from those multiple multiplier-based circuits, in order to produce the required part of the at least one result data element that is to be used to update the value of that data block.

14. An apparatus as claimed in claim 1, wherein the complex valued outer product instruction comprises at least one predicate operand to enable one or more source data elements to be identified as being excluded from the outer product operation.

15. A method comprising:
performing vector operations using processing circuitry;
decoding instructions from a set of instructions to control the processing circuitry to perform the vector operations specified by the instructions; and
employing array storage comprising storage elements to store data blocks, the array storage being arranged to store at least one two-dimensional array of data blocks accessible to the processing circuitry when performing the vector operations;
wherein:
the set of instructions comprises a complex valued outer product instruction specifying a first source operand, a second source operand, and a destination operand, wherein each of the first source operand and the second source operand is a vector operand comprising a plurality of source data elements, each source data element is a complex number formed of a real part and an imaginary part, and the destination operand identifies a given two-dimensional array of data blocks within the array storage; and
the method comprises, in response to the complex valued outer product instruction, employing the processing circuitry to perform an outer product operation using the source data elements of the first source operand and the source data elements of the second source operand in order to generate a plurality of result data elements, where each result data element is a complex number formed of a real part and an imaginary part, and where each real part and each imaginary part of each result data element is associated with one of the data blocks in the given two-dimensional array of data blocks and is used to update a value of that associated data block.

16. A computer program for controlling a host data processing apparatus to provide an instruction execution environment, comprising:
processing program logic to perform vector operations; instruction decode program logic to decode instructions from a set of instructions to control the processing program logic to perform the vector operations specified by the instructions; and
array storage emulating program logic to emulate an array storage comprising storage elements to store data blocks, the array storage being arranged to store at least one two-dimensional array of data blocks accessible to the processing program logic when performing the vector operations;
wherein:
the set of instructions comprises a complex valued outer product instruction specifying a first source operand, a second source operand, and a destination operand, wherein each of the first source operand and the second source operand is a vector operand comprising a plurality of source data elements, each source data element is a complex number formed of a real part and an imaginary part, and the destination operand identifies a given two-dimensional array of data blocks within the array storage; and
the processing program logic is responsive to the complex valued outer product instruction to perform an outer product operation using the source data elements of the first source operand and the source data elements of the second source operand in order to generate a plurality of result data elements, where each result data element is a complex number formed of a real part and an imaginary part, and where each real part and each imaginary part of each result data element is associated with one of the data blocks in the given two-dimensional array of data blocks and is used to update a value of that associated data block.
